(19) United States
(12) Patent Application Publication
(10) Pub. No.: US 2006/0276085 A1
(43) Pub. Date: Dec. 7, 2006

(54) Electrical contact element

(75) Inventors: Wen-Qiang Ma, Shenzhen (CN); Chang-Shin Hsu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/438,503

(22) Filed: May 22, 2006

(30) Foreign Application Priority Data
May 20, 2005 (CN) 200520072138.9

(51) Int. Cl. H01R 4/48

(52) U.S. Cl. 439/862

(57) ABSTRACT

A contact element (10) includes a main portion (200), a mating portion (300) extending from the main portion for electrically connecting to an printed circuit board, a tail portion (100) extending from the main portion for electrically connecting to a cable, a restrictive portion (400) extending from either the tail portion or the main portion and a spring portion (401) extending from the mating portion and restrictively attached to the restrictive portion for preventing abnormal moving of the mating portion.

### BACKGROUND OF THE INVENTION

1. Field of the Invention

The present invention relates to an electrical contact element, and more particularly, to an electrical contact element electrically connecting to a printed circuit board.

2. Description of Related Art

With the development of communication, the mobile phone increases additional functions more and more, such as the microphone. The use of the microphone can release the user's hands, and make the user talk with others conveniently without taking out the mobile phone from the pocket or bag.

To establish a signal connection, the microphone needs a contact element to contact a circuit unit of the microphone to an interior module of the mobile phone. In general, the contact element comprises a tail portion allowing a cable to contact thereto, a mating portion electrically contacting with a contact area of a printed circuit board, and a contacting portion contacting the tail portion to the mating portion.

The mating portion of the contact element needs enough preload to provide a reliable transmission between the microphone and the mobile phone when the contact area of the printed circuit board contacts with the mating portion of the contact element. It is emphasized that, during a process to design the contact element, how to make the contact element have improved preload characteristics is directive.

In addition, the mating portion of the contact element is easy to be deflected away from the contact area of the printed circuit board when the contact element contacts with the printed circuit board, thereby causing the electrical connection therebetween unsteady and therefore influencing the signal transmission.

Hence, an improved electrical contact element is desired to address the problems stated above.

### SUMMARY OF THE INVENTION

An object of the present invention is to provide an electrical contact element, the contact element provided with enough preload makes the contact element have enough normal force, and limits the contact element's abnormal deflection when the mating portion connects with a printed circuit board.

To achieve the above object, an electrical contact element in accordance with the present invention comprises a main portion, a mating portion extending from one end of the main portion, a tail portion extending from the other end of the main portion, a spring portion extending from the mating portion to a free end, and a restrictive portion extending from either the main portion or the tail portion and engaging with the spring portion. The restrictive portion comprises a first portion adapted for limiting the lateral deflection of the mating portion, and a second portion adapted for limiting the upward movement of the mating portion and providing enough preload.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a contact element in accordance with the present invention which received in an insulative housing;

FIG. 2 is a view similar to FIG. 1 but taken from a different perspective view;

FIG. 3 is a perspective view of the contact element in accordance with the present invention; and

FIG. 4 is a view similar to FIG. 3 but taken from a different perspective view.

### DETAILED DESCRIPTION OF THE INVENTION

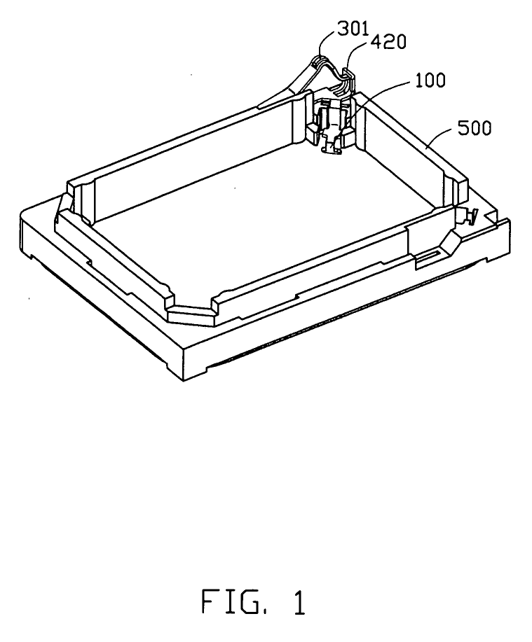

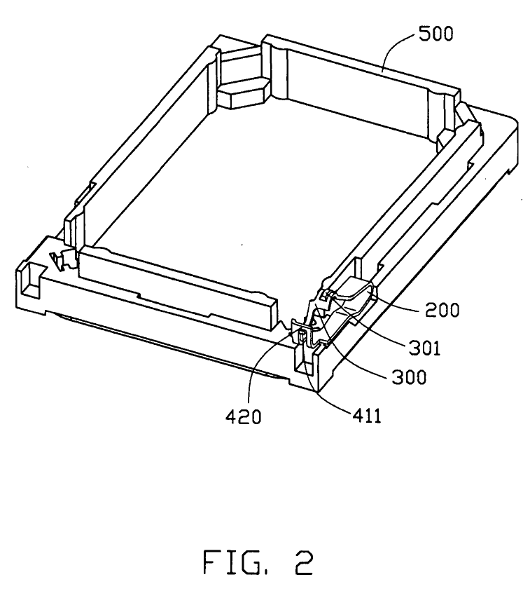

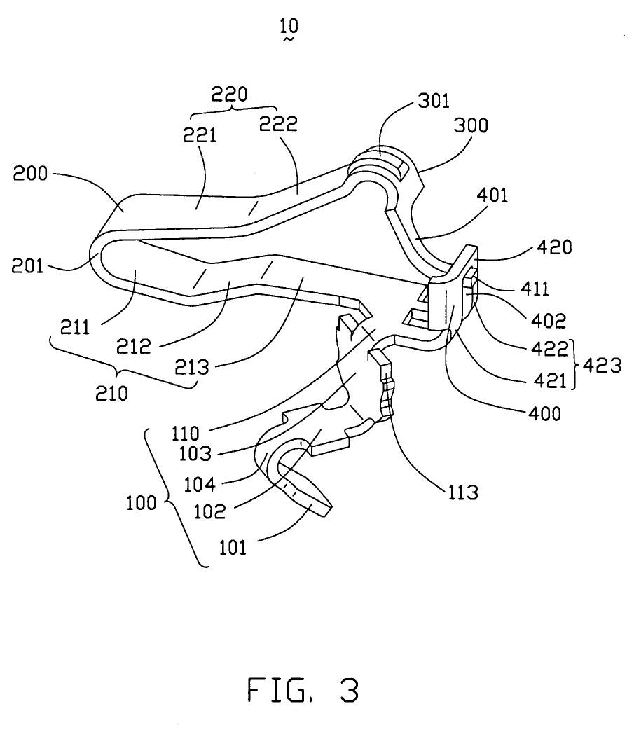

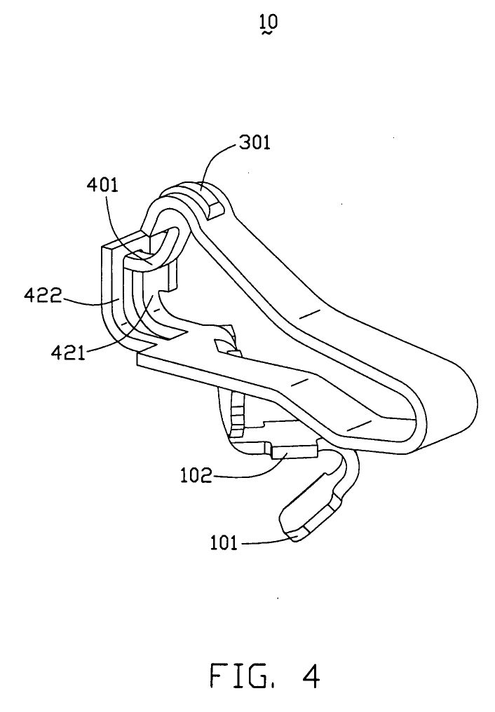

Referring to FIGS. 1-4, a contact element 10 in accordance with the present invention received in an insulative housing 500 comprises a substantially V-shape main portion 200, a mating portion 300 extending from one end of the main portion 200 and capable of connecting with a printed circuit board (not shown), a tail portion 100 extending from the other end of the main portion 200 toward outside, a restrictive portion 400 extending from a joint of the main portion 200 and the tail portion 100, and a spring portion 401 downwardly and forwardly extending from the mating portion 300. In the embodiment shown, although the restrictive portion 400 extends from the joint of the main portion 200 and the tail portion 100, the invention is not so limited. It is contemplated that the restrictive portion 400 could extend from one of the main portion 200 and the tail portion 100.

The main portion 200 comprises a cambered portion 201, and a first arm portion 210, a second arm portion 220 respectively extending from opposite ends of the cambered portion 201. The first arm portion 210 comprises a first connecting portion 211 flatly extending from one end of the cambered portion 210, a first stretching portion 213 parallel to the first connecting portion 211, and an inclined middle portion 212 connecting the first connecting portion 211 to the first stretching portion 213. The second arm portion 220 comprises a second connecting portion 221 upwardly and forwardly extending from the other end of the cambered portion 201, and a second stretching portion 222 upwardly and forwardly extending from the second connecting portion 221.

The mating portion 300 has a cambered form, one end of the mating portion 300 is attached to the second stretching portion 222 of the main portion 200, the other end of mating portion 300 is attached to the spring portion 401. A top surface of middle portion of the mating portion 300 is formed with a cambered projection 301 used for elastically abutting against the printed circuit board.

The tail portion 100 comprises a curved portion 110 extending from one side edge of the first stretching portion 213 with an angle formed between the curved portion 110 and the first stretching portion 213, an enlarged engaging portion 103 downwardly extending from the curved portion 110 and with a width being greater than the width of the curved portion 110, a first flat fixing portion 102 vertically extending from the engaging portion 103, a curved bowed portion 104 extending from the first flat fixing portion 102 and bending backwardly, and a second fixing portion 101 slantways and downwardly extending from the bowed portion 104. The engaging portion 103 has a pair of lateral sides 113. Each lateral side 113 has a plurality of stings (not labeled), by which the contact element 10 interferentially engages with the insulative housing 50. The curved bowed portion 104 allows a cable (not shown) to be twisted therewith, after the cable's twist, the second fixing portion 101 is pushed toward the first flat fixing portion 102 to clamp above cable, then, the cable is soldered to the bowed portion 104.

The restrictive portion 400 is substantially L-shape and is slotted with a receiving space 402, and comprises a first portion 423 extending from an end of the first stretching portion 213 and adapted for limiting the lateral deflection of the mating portion 300, and a transverse second portion 420 adapted for limiting the upward movement of the mating portion 300. The first portion 423 comprises a pair of restrictive arms 421, 422 respectively extending a distance from the first arm portion 220 along a first direction and then respectively bended upwardly along a second direction perpendicular to the first direction. The transverse second portion 420 horizontally connects two ends of the restrictive arms 421, 422.

The spring portion 401 downwardly extending from the end of the mating portion 300, comprises a distal end 411 received in the receiving space 402. Because of the limitation generated by the second portion 420, the distal end 411 could not move up excessively, thereby allowing the contact element 40 to have enough preload at a low position. When the contact area (In this embodiment, the contact area is soldered with conductive material, such as gold.) of the printed circuit board contacts with the mating portion 300 of the contact element 10, the mating portion 300 will generate enough upward normal force, and make the contact element 10 contact with the printed circuit board instantly. In addition, because of the limitation of the restrictive portion 400, the distal end 411 under the press of the printed circuit board will move downwardly in the receiving space 402 and can not deflect away from its predetermined trial, thereby avoiding the mating portion 300 deflecting from the contact area of the printed circuit board, and thus ensuring the reliable connection between the contact element 10 and the printed circuit board. In this embodiment, the restrictive portion 400 adopts two restrictive arms 421, 422 of the first portion 423 and the second portion 420 to provide enough preload and avoid abnormal deflection of the mating portion 300, but the invention is not so limited. It is contemplated that other structure, such as a bowed structure, a triangle structure, which similarly form a receiving space, may be used in lieu of the two restrictive arm 421, 422 and the second portion 420 to achieve above goals.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A contact element adapted for electrically connecting with a printed circuit board, comprising:
a main portion;
a mating portion extending from the main portion adapted for electrically connecting to said printed circuit board;
a tail portion extending from the main portion adapted for electrically connecting to a cable;
a restrictive portion extending from either the tail portion or the main portion; and
a spring portion extending from the mating portion to a free end and restrictively attached to the restrictive portion for preventing abnormal movement of the mating portion.

2. The contact element as claimed in claim 1, wherein the restrictive portion defines a receiving space, and wherein the free end of the spring portion is capable of moving along the receiving space to restrict the movement of the mating portion.

3. The contact element as claimed in claim 1, wherein the restrictive portion comprises a first portion extending from the main portion for avoiding a lateral deflection of the mating portion, and a second portion attached to the first portion for preventing an upward movement of the mating portion.

4. The contact element as claimed in claim 3, wherein the first portion comprises a pair of restrictive arm respectively extending a distance from the main portion along a first direction and then respectively bended upwardly along a second direction perpendicular to the first direction, the second portion horizontally connects with the restrictive arms, the first portion and the second portion together form a receiving space.

5. The contact element as claimed in claim 4, wherein the spring portion downwardly extends from the mating portion, and comprises a distal end received in the receiving space of the restrictive portion and abutting against the second portion.

6. The contact element as claimed in claim 1, wherein the main portion comprises a first arm portion connecting with the mating portion, and a second arm portion connecting with the restrictive portion.

7. The contact element as claimed in claim 6, wherein the main portion further comprises a cambered portion connecting the first arm portion to the second arm portion, the first arm portion comprises a first connecting portion connecting with an end of the cambered portion, a first stretching portion, and a middle portion connecting the first connecting portion to the first stretching portion.

8. The contact element as claimed in claim 1, wherein the mating portion with a cambered shape forms a cambered projection on a top surface thereof.

9. The contact element as claimed in claim 1, wherein the tail portion extends from the main portion with an angle formed between the tail portion and the main portion.

10. The contact element as claimed in claim 1, wherein the angle is less than 90 degree or equal to.

11. The contact element as claimed in claim 1, wherein the tail portion comprises a curved portion extending from the main portion toward outside, an engaging portion extending from the curved portion and with a width being greater than the width of the curved portion.

12. The contact element as claimed in claim 11, wherein the engaging portion forms a plurality of stings on two lateral sides thereof for interferentially engaging with a complementary element.

13. The contact element as claimed in claim 11, wherein the tail portion further comprises a first fixing portion extending from the engaging portion, a bowed portion extending from the first fixing portion, and a second fixing portion downwardly extending from the bowed portion adapted for attaching a cable to the first fixing portion.

14. The contact element as claimed in claim 1, wherein the restrictive portion extends from the joint of the tail portion and the main portion.

15. The contact element as claimed in claim 1, wherein the restrictive portion comprises a bowed structure extending from the main portion and limiting abnormal deflection of the spring portion for providing a reliable connection between the mating portion of the contact element and an contact area of the printed circuit board.

16. A contact element for electrically connecting with a printed circuit board, comprising:
a main portion;
a mating portion extending from one end of the main portion for electrically connecting to a printed circuit board;
a spring portion extending from the mating portion and defining a distal end;
a restrictive portion extending from the other end of the main portion;
wherein the restrictive portion comprises a first portion, a second portion attached to the first portion, and defines a receiving space by the first portion and the second portion whereby the distal end of the spring portion is received in the receiving space and abnormal deflection of the mating portion is limited.

17. The contact element as claimed in claim 16, wherein the contact element comprises a tail portion extending from the main portion for connecting with a complementary element.
